(19) United States
(12) Patent Application Publication
(10) Pub. No.: US 2018/0111397 A1
(43) Pub. Date: Apr. 26, 2018

(54) PRINTER AND CONTROL METHOD OF A PRINTER

(71) Applicant: SEIKO EPSON CORPORATION, Tokyo (JP)

(72) Inventor: Kenichi Hirabayashi, Shiojiri-shi (JP)

(73) Assignee: SEIKO EPSON CORPORATION, Tokyo (JP)

(21) Appl. No.: 15/792,007

(22) Filed: Oct. 24, 2017

(30) Foreign Application Priority Data
Oct. 26, 2016 (JP) 2016-209309

(51) Int. Cl. B41J 13/00; B41J 3/407; B41J 15/16

(52) U.S. Cl. CPC B41J 13/0009; B41J 15/16; B41J 3/4075

(57) ABSTRACT

Provided is a printer that prints on continuous print media, and can assure good print quality without troubling the user when the printer is used in conjunction with an optional device that affects recording medium conveyance. The printer conveys and prints on a continuous print medium, is used with an optional device having a configuration that holds part of the print medium, and includes a print mechanism that prints on the print medium; a conveyance mechanism that conveys the print medium; and a controller that controls the print mechanism and conveyance mechanism. The controller detects the optional device that is used, and based on the detection result, determines the control content of at least the print mechanism or the conveyance mechanism.

### CROSS-REFERENCE TO RELATED APPLICATION

This application claims priority under 35 U.S.C. § 119 to Japanese Patent Application No. 2016-209309, filed Oct. 26, 2016. The entire disclosure of Japanese Patent Application No. 2016-209309 is hereby incorporated herein by reference.

### BACKGROUND

The present disclosure relates to a printer that prints to a continuous recording medium, and relates more particularly to a printer capable of assuring good print quality without troubling the user when the printer is used in conjunction with an optional device that affects recording media conveyance.

Printers to which optional devices such as a document sorter is installed, the document sorter is for sorting printouts as they are discharged, are known from the literature. For example, JP-A-2014-30304 describes technology that considers the change in the load on a DC motor when a discharge tray is installed as the optional device to set control gain optimized for a specific target position and media conveyance speed, thereby adjusting drive with good performance tracking a specific target position and conveyance speed.

### SUMMARY

However, the drive source of some optional devices may be disposed separately from the printer, and may convey the medium at a different conveyance rate than the conveyance speed of the printer itself. This configuration is useful when the same tension should be applied to the paper (medium) between the optional device and the printer.

However, when the control technology described in JP-A-2014-30304 is applied to a configuration having independent drive sources as described above, a difference between the actual conveyance rate and the conveyance rate controlled to achieve the target speed may result from the effect of the optional device even if the print medium is conveyed at the target speed in the printer, and print quality may drop.

Various optional devices each affecting print media conveyance in different ways may also be usable, depending on the printer, but in this case, the user must adjust media conveyance appropriately to the optional device that is installed, and this process can be quite tedious.

An objective of certain embodiments is therefore to provide a printer that prints on continuous print media, and can assure good print quality without troubling the user when the printer is used in conjunction with an optional device that affects recording medium conveyance.

According to one embodiment, a printer conveys and prints on a continuous print medium, and is used with an optional device having a configuration that holds part of the print medium, the printer includes: a print mechanism that prints on the print medium; a conveyance mechanism that conveys the print medium; and a controller that detects the optional device that is used, and based on the detection result, determines control content of at least the print mechanism or the conveyance mechanism.

Because printing and media conveyance control are optimized according to the optional device that is used, the effect the optional device has on the print medium is considered, and high print quality can be maintained. Furthermore, because this adjustment is done by the controller, the user is not bothered.

In another embodiment, the conveyance mechanism has a conveyance roller that holds the print medium and supplies the print medium to a printing position; and when the controller detects an optional device that is used, the controller sets the conveyance roller nipping force higher than when a used optional device is not detected.

This aspect of the invention can minimize print media conveyance errors.

Further preferably in another embodiment, the controller determines the control content based on the type of optional device that is detected.

Because the control content can be changed according to the type of installed optional device, this embodiment enables more appropriate control.

Further preferably in another embodiment, the conveyance mechanism has a conveyance roller that holds the print medium from both sides, and supplies the print medium to a printing position; and the controller determines at least one of the conveyance pitch, printing amount, and conveyance roller nipping force as the control content.

This embodiment can maintain high print quality.

Further preferably in another embodiment, the controller determines the type of optional device based on information the printer acquires from a connected sequencer, information acquired from the optional device, or the shape of the cable connecting the printer to the optional device.

Because the controller identifies the optional device in this embodiment, control can be adjusted appropriately to the optional device without involving the user.

Further preferably in another embodiment, the controller determines the control content based on adjustment information previously set for the type of optional device.

Furthermore, because adjustment information for each optional device is previously stored in this embodiment, control can be adjusted immediately without troubling the user each time.

Further preferably in another embodiment, the adjustment information is stored in the printer; and the adjustment information can be edited by another device that can communicate with the printer.

This embodiment enables the user to edit the adjustment information, and user convenience is good.

Further preferably in another embodiment, the optional device is a supply device that supplies the print medium to the printer, a peeling device that peels labels of the print medium from a liner, or a rewinding device that rewinds the print medium after printing.

Further preferably in another embodiment, the print mechanism includes an inkjet head.

In another embodiment, a control method of a printer that prints on a continuous print medium, and can be used with an optional device having a configuration that holds part of the print medium, includes steps of: detecting the optional device that is used; and based on the detection result, determining control content of at least the printing process or the print medium conveyance process.

Further preferably in another embodiment, the control method also includes steps of: receiving the type of optional device input to a device capable of communicating with the printer, and adjustment information corresponding to the type of optional device; relationally storing the type of optional device and the adjustment information that were received; and determining the control content based on the type of optional device detected and the stored adjustment information.

This embodiment enables remotely setting and editing the adjustment information, and user convenience is good.

Other objects and attainments together with a fuller understanding of the invention will become apparent by referring to the following description and the accompanying drawings.

### BRIEF DESCRIPTION OF THE DRAWINGS

FIG. 1 is an oblique view of a printer according to the invention.

FIG. 2 is a block diagram illustrating the relationship between a printer according to the invention and a peripheral device.

FIG. 3 illustrates an adjustment information table 11.

FIG. 4 schematically illustrates the structure of a conveyance roller 31.

FIG. 5 is a side view schematically illustrating installation of a paper supply device 40 and paper rewinding device 50.

FIG. 6 is a side section view schematically illustrating installation of a peeler mechanism 60.

FIG. 7 is a flow chart of steps in a process determining the correction appropriate to an optional device.

### DESCRIPTION OF EMBODIMENTS

An embodiment of the present invention is described below with reference to the accompanying figures. However, the embodiment described below does not limit the technical scope of the invention. Note that in the figures like or similar parts are identified by the same reference numerals or reference symbols.

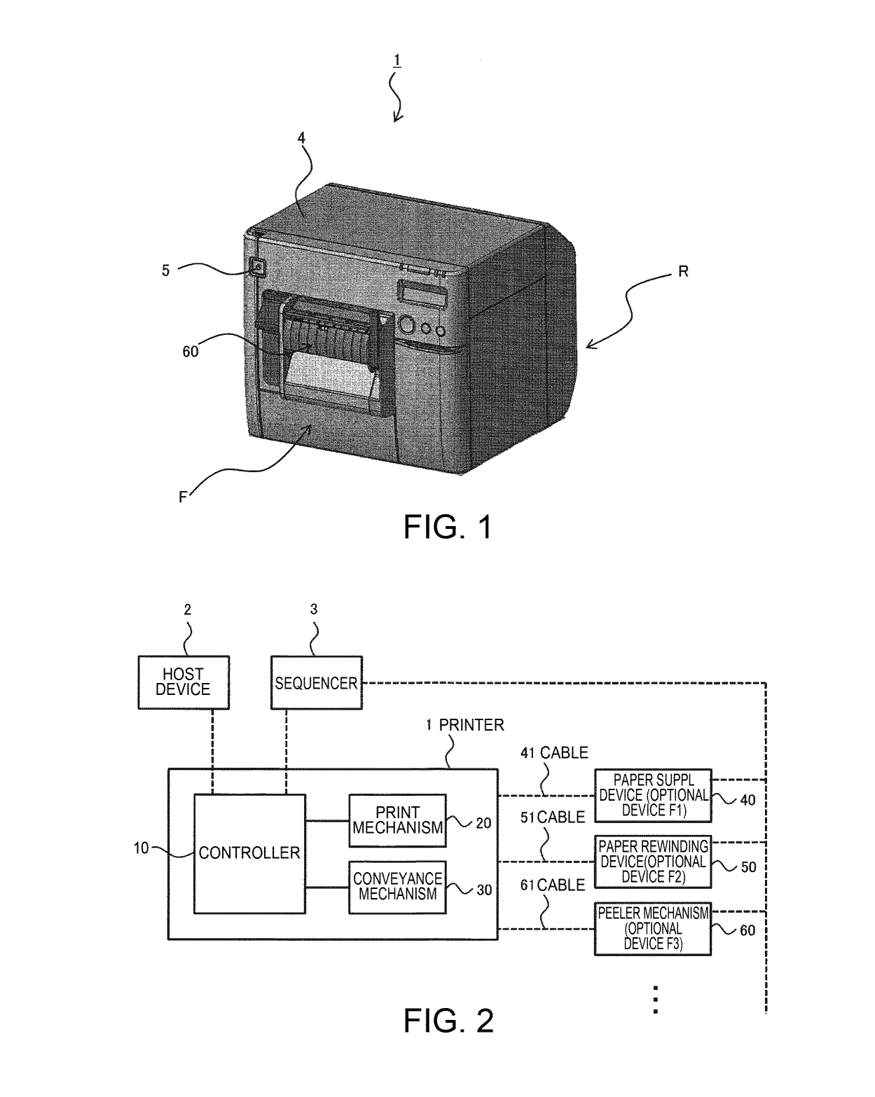

FIG. 1 is an oblique view of a printer according to a preferred embodiment of the invention. FIG. 2 is a block diagram illustrating the configuration of a peripheral device and a printer according to the invention. The printer 1 shown in FIG. 1 and FIG. 2 is a printer according to the invention, and this printer 1 is a printer that prints to continuous paper 6 (print medium) such as roll paper or fanfold paper. The printer 1 can be used with multiple optional devices (F1, F2, F3, and so forth) that grip part of the paper 6 and affect conveyance of the paper 6, detect the optional devices that are installed (used), and adjust control of printing to the paper 6 (printing control) and control of conveying the paper 6 (conveyance control) optimally to the optional device based on the detected optional device and adjustment information previously set for that optional device. As a result, control appropriate to the actual printer setup and usage is applied without troubling the user, and excellent print quality can be assured regardless of what optional device is used.

One example of a printer 1 according to this embodiment of the invention is an inkjet label printer that prints on roll paper, fanfold paper, or other continuous paper. The printer 1 in this example may be used in a production line in a factory, for example.

As shown in FIG. 1, the printer 1 has a basically rectilinear case 4, prints to paper 6 stored inside the case 4, or paper 6 supplied from the rear of the case 4 (the side indicated by R in FIG. 1), and discharges the printed paper 6 from the front of the case 4 (the side indicated by F in FIG. 1).

The printer 1 has a power button 5 on the front (the surface indicated by F in FIG. 1) of the case 4, and the user can install a peeler mechanism 60 as an optional device (F3) to the same side as the power button 5.

As shown in FIG. 2, the functional configurations of the printer 1 include a controller 10, print mechanism 20, and conveyance mechanism 30. The printer 1 also has an interface to peripheral devices, and connects to a host device 2, sequencer 3, paper supply device 40 (optional device F1), paper rewinding device 50 (optional device F2), and peeler mechanism 60 (optional device F3).

The controller 10 controls other parts of the printer 1, and is comprised of hardware such as a CPU, RAM, ROM, and other peripheral circuits not shown. When a print request is received from the host device 2, for example, the controller 10 controls operation of the print mechanism 20 and conveyance mechanism 30 to print as requested on the paper 6. The controller 10 also executes an adjustment process (determining a correction value) that adjusts printing control and conveyance control appropriately to the installed (connected) optional device. The specific content of this adjustment process is described below.

The controller 10 stores the adjustment information table 11 in NVRAM. The adjustment information table 11 is a data table relationally storing adjustment information for each optional device that can be attached to the printer 1, in other words, optional devices that can be used with the printer 1. The information stored in the adjustment information table 11 may be set by the user of the printer 1 and stored in NVRAM. The settings in the adjustment information table 11 may also be preconfigured and set during the manufacturing process.

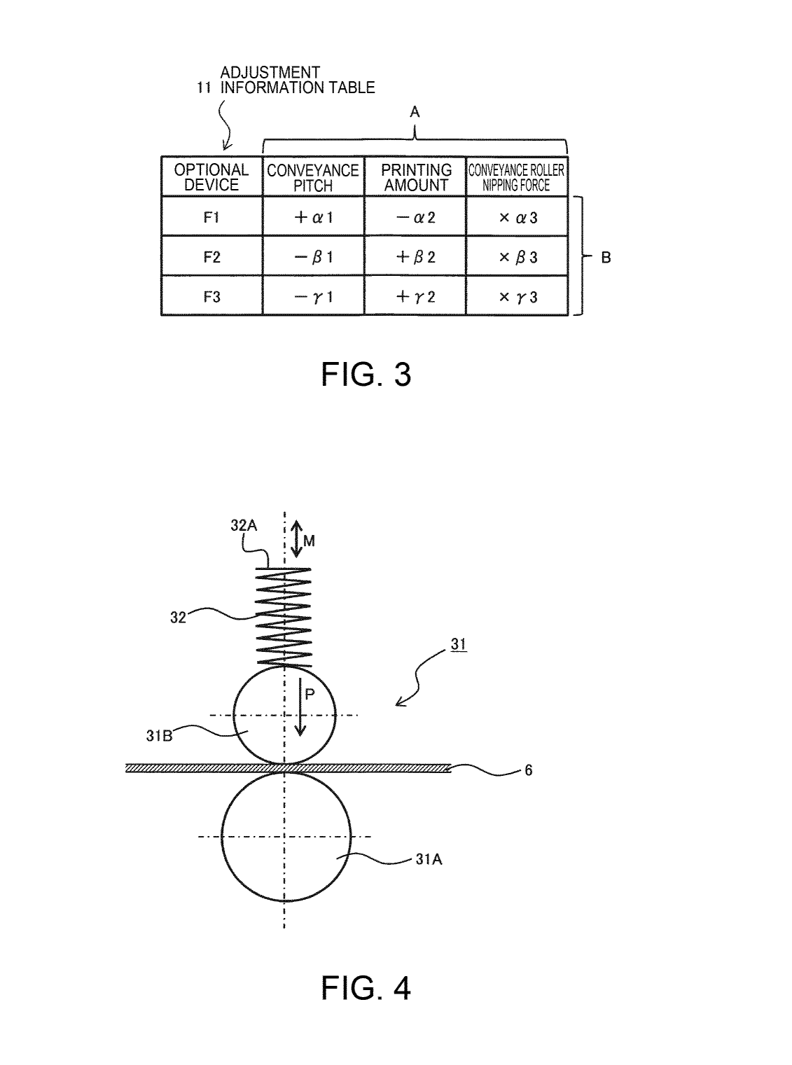

FIG. 3 shows an example of an adjustment information table 11. In the example in FIG. 3, adjustment information is relationally stored for three optional devices F1, F2, F3. The adjustment information defines a correction value for control parameters (indices) related to printing control and media conveyance control. In this example, correction values (such as +α1) as shown in B in FIG. 3 are set for the control parameters shown in A in FIG. 3, specifically, conveyance pitch, printing amount, and conveyance roller nipping force.

The conveyance pitch is the angle of rotation indicating how much the roller turns when the conveyance roller 31 described below conveys the paper 6 a unit distance. The printing amount is the amount printed on the paper 6 relative to a command conveying the paper 6 the unit distance. The conveyance roller nipping force is the force by which the conveyance roller 31 described below holds the paper 6.

The correction value is set as a value indicating the increase or decrease, or as a value indicating a ratio of, the value of the control parameter (standard value) that is used when the optional device is not installed. A correction value of +α1 therefore means that the value equal to the (standard value+α1) is used for printing control or conveyance control when the optional device is installed, and a correction value of ×α1 means that the value equal to the (standard value×α1) is used for printing control or conveyance control when the optional device is installed.

In control based on the adjustment information table 11 shown in FIG. 3, media conveyance and printing are controlled when optional device F1 is installed by adjusting the conveyance pitch to (standard value+α1), the printing amount to (standard value−α2), and the conveyance roller nipping force to (standard value×α3).

At least one of the conveyance pitch, printing amount, and conveyance roller nipping force parameters is adjusted in this example, but correction values may be set so that the controller 10 adjusts multiple control parameters, and the standard values of multiple control parameters are adjusted to control operation appropriately to the detected optional device.

Furthermore, when multiple optional devices are installed, adjustment of the standard values for each installed optional device may be combined. For example, in the example in FIG. 3, if optional device F1 and optional device F2 are both installed, conveyance and printing are controlled by adjusting the conveyance pitch to (standard value+α1−β1), and the conveyance roller nipping force to (standard value×α3×β3).

This process is executed by the controller 10 shown in FIG. 2, but more specifically is executed by a CPU operating according to a program (firmware) stored in ROM, for example, or by operation of hardware such as an ASIC.

Next, the print mechanism 20 includes a printhead (inkjet head) with multiple nozzles that eject ink, and a platen disposed to a position opposite the printhead with the paper 6 conveyed therebetween, and executes a printing process on the conveyed paper 6. The printhead has reserve nozzles, and adjusting the printing amount is done using these reserve nozzles.

The conveyance mechanism 30 conveys the paper 6. The paper 6 conveyed by the conveyance mechanism 30 is delivered from inside the printer 1 or from an external paper 6 supply source, supplied to the printing position (the position of the printhead on the conveyance path), and discharged after printing. There is an opening in the back of the case 4, and paper 6 supplied from an external source is supplied through this opening to the printing position. A paper exit from which the paper 6 is discharged after printing is disposed in the front of the case 4.

The conveyance mechanism 30 also has a conveyance roller 31. The conveyance roller 31 is disposed upstream from the printhead in the conveyance direction of the paper 6, and supplies paper 6 delivered from a source inside or outside the case 4 to the printhead. The conveyance precision of the paper 6 by the conveyance roller 31 directly affects the print quality, and the effect of the conveyance roller 31 is particularly great in a printer 1 using an inkjet printhead.

FIG. 4 schematically illustrates the structure of the conveyance roller 31. As shown in FIG. 4, the conveyance roller 31 has a pair of rollers (31A, 31B) that hold the paper 6 from above and below. Roller 31A is a drive roller, and is turned by drive force transmitted from a drive device (motor, power transfer mechanism) not shown. Roller 31B is a follower roller, and is pressed by a spring 32 to the roller 31A side (in the direction of arrow P in FIG. 4).

When the paper 6 is held between roller 31B and roller 31A, and roller 31A is driven rotationally, the paper 6 is conveyed by friction between the roller 31A and paper 6, and roller 31B is turned by friction between the paper 6 and roller 31B.

Disposed to the top end 32A of the spring 32 is a lift mechanism, not shown, that moves the position of the top end 32A of the spring 32 up and down (in the direction of arrow M in FIG. 4). The pressure on the roller 31B, that is, the nipping force of the paper 6 by the conveyance roller 31, can be adjusted by the lift mechanism. When the position of the top end 32A of the spring 32 is moved to the roller 31B side (down) as seen in FIG. 4, the nipping force increases, and friction between the conveyance roller 31 and paper 6 increases. Increasing the friction decreases slipping of the paper 6. Conversely, when the position of the top end 32A of the spring 32 moves away from the roller 31B (up), the nipping force decreases, and friction between the conveyance roller 31 and paper 6 decreases. Decreasing the friction increases slipping of the paper 6.

The lift mechanism can be embodied by a cam mechanism, for example.

When the optional device described below is installed and the paper 6 is conveyed, different tension may be applied from the upstream side or downstream side in the conveyance direction to the paper 6 at the position of the conveyance roller 31 by the optional device holding part of the paper 6. This difference in tension causes the actual conveyance distance of the paper 6 relative to a specific rotation of the conveyance roller 31 to differ when the optional device is installed and when the optional device is not installed.

In addition to the configurations shown in FIG. 2, the printer 1 also has a user interface (display unit, operating unit), and an interface to peripheral devices. Communication with the peripheral devices (external devices) is controlled by the controller 10.

As shown in FIG. 2, the printer 1 is connected to a host device 2. The host device 2 may be a host computer that sends print requests to the printer 1, and can communicate with the printer 1. A printer driver (program) for the printer 1, and a utility (program) are installed on the host device 2, and the user can configure (edit) the values (information) in the adjustment information table 11 through the utility.

The sequencer 3 is disposed to a production line having multiple devices. When the printer 1 is installed to a production line as in this example, the printer 1 is configured to communicate with the sequencer 3, and operates as controlled by the sequencer 3. The sequencer 3 can communicate with each optional device, and controls the operation of each optional device. The printer 1 can acquire information about each optional device from the sequencer 3.

As described above, various optional devices may be connected to and used with the printer 1. As shown in FIG. 2, the printer 1 in this embodiment is used with at least one optional device, which in this example may be a paper supply device 40 (F1, supply device), paper rewinding device 50 (F2, rewinding device), and peeler mechanism 60 (F3, peeling device). As shown in FIG. 2, the printer 1 is connected to each optional device through a communication cable (41, 51, 61), and communicates with the corresponding optional device through the appropriate cable.

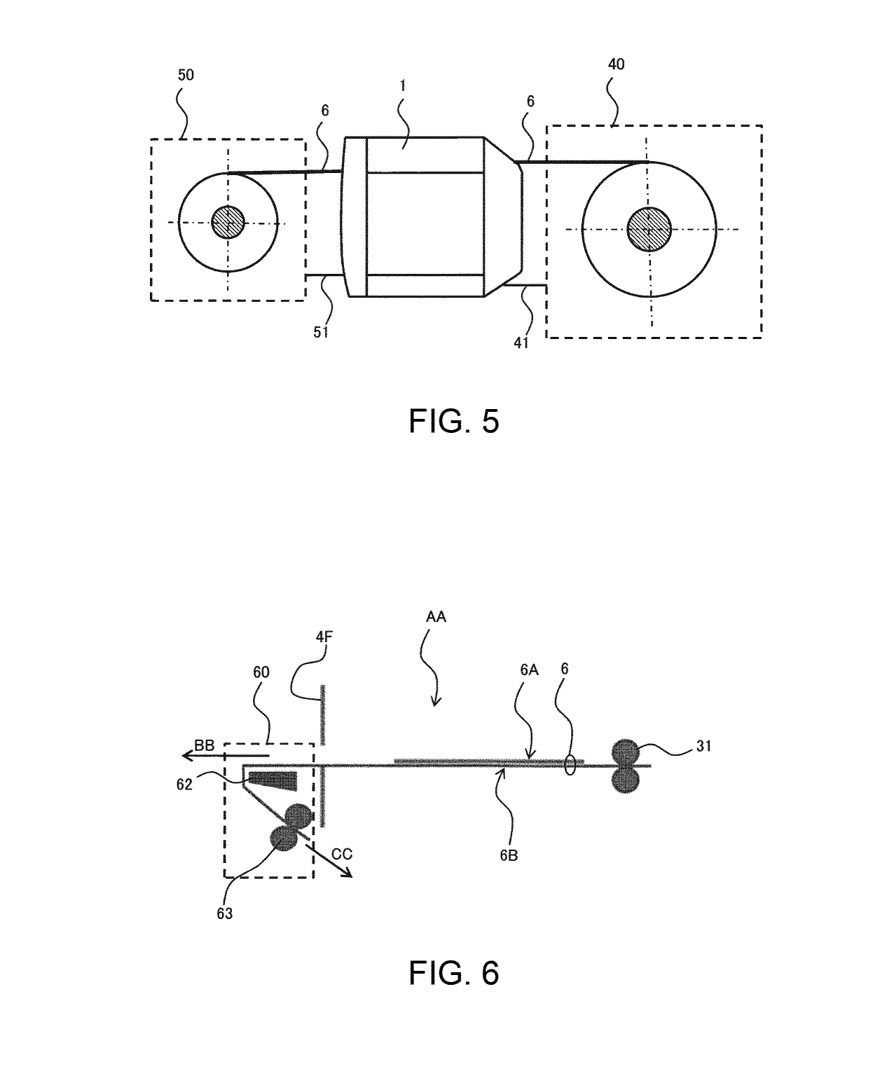

FIG. 5 is a side view schematically illustrating a configuration having a paper supply device 40 and paper rewinding device 50 installed. The paper supply device 40 supplies the paper 6, is disposed to the back side of the printer 1, stores the paper 6 in a paper roll, and supplies the paper 6 from an opening in the back of the printer 1 to the printer 1. The paper supply device 40 includes a mechanism for rotating the spindle of the rolled paper 6, and a roller for conveying the paper 6 delivered from the paper roll.

The paper rewinding device 50 is a device for rewinding paper 6 discharged from the printer 1 into a roll, and is disposed to the front of the printer 1. The paper rewinding device 50 has a mechanism for rotating the spindle onto which the paper 6 is wound, and rewinds the paper 6 discharged from the paper exit in the front of the printer 1. The paper rewinding device 50 also has rollers for conveying the paper 6 discharged from the paper exit.

When the printer 1 prints, the paper 6 is conveyed continuously from the paper supply device 40 to the paper rewinding device 50, and the paper supply device 40 that holds the paper 6, and the force applied by the paper rewinding device 50 to the paper 6, affect the behavior of the paper 6 near the conveyance roller 31.

Note that the printer 1 may also be used with only one of the paper supply device 40 and paper rewinding device 50 installed.

FIG. 6 is a side section view schematically illustrating when the peeler mechanism 60 is installed.

The peeler mechanism 60 is a device that peels labels 6A from the liner 6B when the paper 6 is label paper having labels 6A affixed to a continuous liner 6B. As shown in FIG. 1, the peeler mechanism 60 is installed to the front of the printer 1. As shown in FIG. 6, the peeler mechanism 60 has a peeler 62, and a discharge roller 63. The space indicated by the AA in FIG. 6 is inside the printer 1.

As shown in FIG. 6, after printing is completed, the paper 6 conveyed from the conveyance roller 31 is discharged to the outside of the printer 1 (to the outside from the case front 4F), and conveyed to the peeler mechanism 60. The paper 6 then travels around the peeler 62 of the peeler mechanism 60, and the printed label 6A is peeled from the liner 6B. The label 6A is then discharged in the direction of arrow BB in FIG. 6. The liner 6B is discharged by the discharge roller 63 in the direction of arrow CC in FIG. 6.

The discharge roller 63 holds the liner 6B with a pair of rollers, is driven rotationally, and affects the behavior of the continuous paper 6, particularly the paper 6 near the conveyance roller 31.

The printer 1 in this example is configured as described above. Operation of the printer 1 is described below.

Configuring (editing) the adjustment information table 11 described above is described next. The user starts an adjustment information configuration utility on the host device 2 or other computer (terminal device) that can communicate with the printer 1, and inputs an identifier (type) of optional device, control parameters, and correction values to the input interface provided by the utility.

When the user finishes and confirms the input, the utility sends the input identifier of the optional device and adjustment information (control parameters and correction values) to the printer 1. The controller 10 of the printer 1 relationally sets (stores) the input identifier of the optional device and adjustment information sent from the utility in the adjustment information table 11.

Note that a configuration enabling the user to set (input) the adjustment information using the user interface (display unit, operating unit) of the printer 1 is also conceivable.

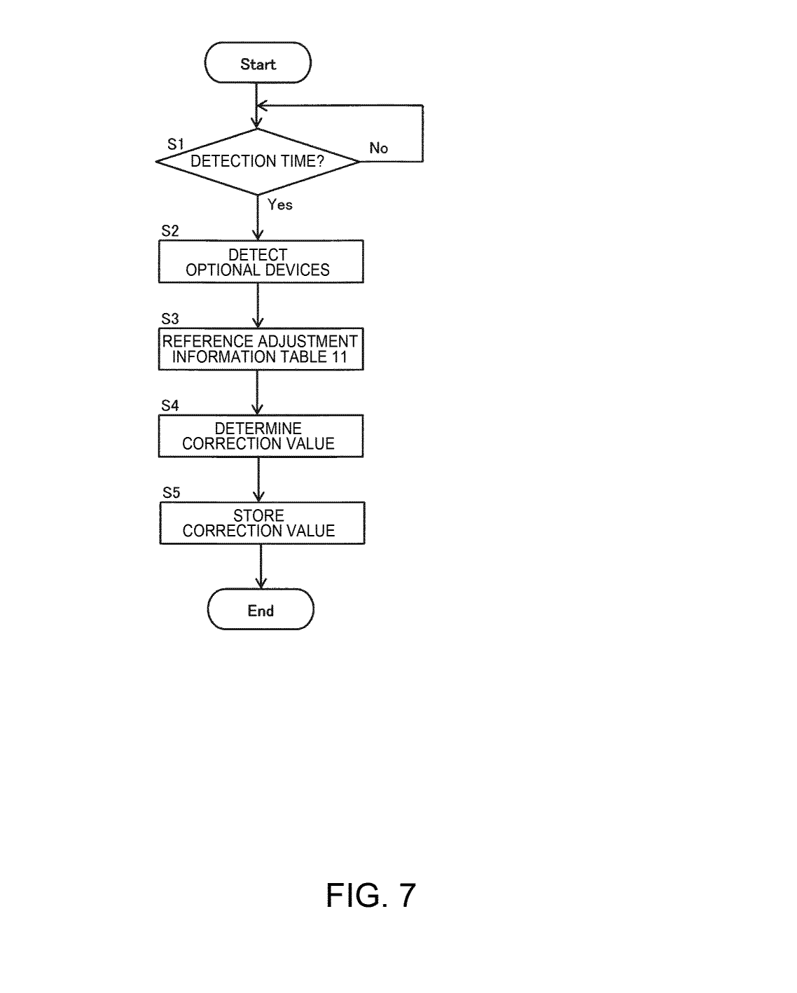

The process whereby the printer 1 determines the adjustment information (correction values) is described next. FIG. 7 is a flow chart of steps in the process determining the correction values appropriate to a particular optional device. First, the controller 10 determines if the timing for detecting optional devices installed to the printer 1 has come (FIG. 7, step S1).

This detection timing may be, for example, when the printer 1 power turns on, when an optional device is installed or removed, when a specific time has passed, or when a detection command is received, and the controller 10 determines the detection timing has come when any of these or other multiple defined times has come. Note that the power turns on when the power button 5 is operated by the user and the printer 1 (controller 10) starts up. When an optional device is installed or removed is when the cable (41, 51, 61) of the optional device was plugged into the connector of the printer 1, or disconnected the cable from the connector, by the user. When a specific time has passed is when a predetermined time has elapsed since the last time an optional device was detected. When a detection command is received is when adjustment information is received from the user through the user interface of the host device 2 or printer 1.

The controller 10 waits until the detection time arrives (FIG. 7, step S1: No), and when the detection time arrives (FIG. 7, step S1: Yes), detects the optional devices that are installed (connected) at that time (FIG. 7, step S2). Detection of optional devices includes the controller 10 determining if an optional device is installed, and identifying each optional device that is installed.

To identify an optional device, the controller 10 communicates with the optional device through the corresponding cable (41, 51, 61) and acquires the identifier (F1, F2, F3) stored by the optional device. As the method of acquiring the identifier of an optional device, the controller 10 may determine the identifier of the optional device from the shape of the cable (41, 51, 61) connected to the connector of the printer 1, and acquire the identifier of the optional device. The controller 10 may also communicate with the sequencer 3 and acquire the identifier of the optional device from the sequencer 3.

In this way, the controller 10 acquires the identifier of the installed optional device, detects the optional device, then references the adjustment information table 11 (FIG. 7, step S3) and determines the correction value (FIG. 7, step S4).

More specifically, the controller 10 accesses the adjustment information table 11 described based on FIG. 3, and acquires the correction values for the control parameters related to the identifier (F1, F2, F3) of the optional device detected in step S2. For example, to adjust the conveyance pitch, if the detected optional device, that is, the installed optional device, is a paper supply device 40 (F1), the controller 10 acquires the correction value+α1 related to optional device F1.

The controller 10 determines the acquired correction values to be the correction value to use for printing or conveyance control, and stores that correction value (FIG. 7, step S5) relationally to the corresponding parameter. More specifically, the controller 10 stores the correction value relationally to the control parameter in NVRAM.

In this way, the correction value appropriate to the operating environment of the device at that time is determined, and that correction value is reflected in the following printing processes and conveyance processes. More specifically, controlling the actual conveyance of the paper 6 and printing to the paper 6 when a print request is received from the host device 2, for example, the controller 10 corrects the value of the control parameter related to the stored correction value based on the correction value, and uses the corrected value as the control parameter value used for controlling the operation of the print mechanism 20 and conveyance mechanism 30. For example, if a correction value of +α1 is stored for the conveyance pitch control parameter, the controller 10 controls the conveyance mechanism 30 using (standard value+α1) for the conveyance pitch.

Note that as control based on the corrected control parameter, the controller 10 may execute a simplified control of changing the nipping force of the conveyance roller 31 according to whether or not an optional device is installed. In this case, the controller 10 stores the value of the nipping force of the conveyance roller 31 corresponding to whether or not an optional device is installed instead of the adjustment information table 11. At the detection timing, the controller 10 then detects if an optional device is installed, and therefore controls conveyance using the nipping force of the conveyance roller 31 stored relationally to the detection result.

When an optional device is installed, the conveyance precision of the paper 6 by the conveyance roller 31 may drop due to the effect of the force the optional device applies to the paper 6. More specifically, slipping between the conveyance roller 31 and paper 6 occurs easily. Therefore, to reduce slipping between the conveyance roller 31 and paper 6, the nipping force of the conveyance roller 31 when the optional device is installed is preferably set to a higher value than the nipping force of the conveyance roller 31 when the optional device is not installed. This control method is particularly effective when the precision of printing by the printer 1 is prioritized over the precision of processing the paper 6 by the optional device. However, if the nipping force of the conveyance roller 31 is constantly high, the conveyance roller 31 may deteriorate more quickly. Because the conveyance roller nipping force is changed appropriately to the installed optional device by the control described above, deterioration of the conveyance roller 31 is reduced, and the conveyance precision of the paper 6 by the conveyance roller 31 can be maintained.

As described above, because printing control and conveyance control are optimized for the installed optional device by a printer 1 according to this embodiment and variations thereof, high print quality can be maintained by considering the effect of optional devices on the paper 6. Furthermore, because this adjustment is done by the controller 10, the user is not bothered.

When an installed optional device is detected, the nipping force of the conveyance roller 31 is set higher than when an installed optional device is not detected, and paper 6 conveyance errors can be minimized.

Furthermore, because the control content can be changed according to the type of installed optional device, more appropriate control is possible.

The adjusted control parameter is at least one of the conveyance pitch, printing amount, and conveyance roller nipping force, and high print quality can be maintained.

Furthermore, because the controller 10 detects (identifies) the optional device that is installed, control can be adjusted appropriately to the optional device without involving the user.

Furthermore, because the correction values for each optional device are previously stored in an adjustment information table 11, control can be adjusted immediately without troubling the user each time.

Furthermore, an interface enabling the user to set the correction values in the adjustment information table 11 is provided, and user convenience is good.

Furthermore, the invention is particularly effective in an inkjet printer, which requires precise media conveyance, and a label printer, which requires precise printing.

The invention is more effective in an environment where the printer may be connected to and used with numerous optional devices, such as a printer that is used installed on a production line.

The invention being thus described, it will be obvious that it may be varied in many ways. Such variations are not to be regarded as a departure from the spirit and scope of the invention, and all such modifications as would be obvious to one skilled in the art are intended to be included within the scope of the following claims.

What is claimed is:

1. A printer that conveys and prints on a continuous print medium, and is used with an optional device having a configuration that holds part of the print medium, the printer comprising:
a print mechanism that prints on the print medium;
a conveyance mechanism that conveys the print medium; and
a controller that detects the optional device that is used, and based on the detection result, determines control content of at least the print mechanism or the conveyance mechanism.

2. The printer described in claim 1, wherein:
the conveyance mechanism has a conveyance roller that holds the print medium and supplies the print medium to a printing position; and
when the controller detects an optional device that is used, the controller sets the conveyance roller nipping force higher than when a used optional device is not detected.

3. The printer described in claim 1, wherein:
the controller determines the control content based on the type of optional device that is detected.

4. The printer described in claim 3, wherein:
the conveyance mechanism has a conveyance roller that holds the print medium from both sides, and supplies the print medium to a printing position; and
the controller determines at least one of the conveyance pitch, printing amount, and conveyance roller nipping force as the control content.

5. The printer described in claim 3, wherein:
the controller determines the type of optional device based on information the printer acquires from a connected sequencer, information acquired from the optional device, or the shape of the cable connecting the printer to the optional device.

6. The printer described in claim 3, wherein:
the controller determines the control content based on adjustment information previously set for the type of optional device.

7. The printer described in claim 6, wherein:
the adjustment information is stored in the printer; and
the adjustment information can be edited by another device that can communicate with the printer.

8. The printer described in claim 1, wherein:
the optional device is a supply device that supplies the print medium to the printer, a peeling device that peels labels of the print medium from a liner, or a rewinding device that rewinds the print medium after printing.

9. The printer described in claim 1, wherein:
the print mechanism includes an inkjet head.

10. A control method of a printer that prints on a continuous print medium, and can be used with an optional device having a configuration that holds part of the print medium, comprising:
detecting the optional device that is used; and
based on the detection result, determining control content of at least the printing process or the print medium conveyance process.

11. The control method of a printer described in claim 10, further comprising:
receiving the type of optional device input to a device capable of communicating with the printer, and adjustment information corresponding to the type of optional device;
relationally storing the type of optional device and the adjustment information that were received; and
determining the control content based on the type of optional device detected and the stored adjustment information.
